(19) United States
(12) Patent Application Publication
(10) Pub. No.: US 2016/0239164 A1
(43) Pub. Date: Aug. 18, 2016

(54) CONTEXT-BASED CONTROL OF PROPERTY SURFACING

(71) Applicant: Microsoft Technology Licensing , LLC, Redmond, WA (US)

(72) Inventors: Shaleen Sharma, Uttar Pradesh (IN); Anirban Saha, West Bengal (IN); Hemant Raj, Hyderabad (IN)

(21) Appl. No.: 14/625,510

(22) Filed: Feb. 18, 2015

(51) Int. Cl. G06F 3/0482; G06F 3/0485

(52) U.S. Cl. CPC G06F 3/0482; G06F 3/0485

(57) ABSTRACT

A user interaction is detected, selecting a unit with a user input mechanism. A current context is identified and a set of property categories is identified. The set of properties categories is arranged in an order. Properties for the selected unit, and corresponding attributes for those properties, are retrieved, categorized into the set of categories (based on the attributes and the context) and surfaced, in the order, for user interaction. Visual indicia can be displayed, identifying one or more categories that the properties belong to.

### BACKGROUND

Computing systems are currently in wide use. Computing systems are often used by organizations in order to assist them in carrying out tasks, activities, and workflows.

Some computing systems have entities or data records that represent physical objects or physical units. For instance, some organizations use computer systems that have entities or records that represent products, equipment, or other physical units.

In such systems, a computing system may control a surfacing system to surface the entities or records for user interaction. In doing so, the surfacing system surfaces not only a description of the physical unit, but often a set of properties that correspond to, and can further define, the physical unit. The surfacing system may surface the properties in a variety of different contexts. Currently, the list of properties corresponding to physical units may be relatively lengthy. In fact, it may be very difficult for the surfacing system to display all of the properties on a display screen, especially the display screen of a mobile device (such as a mobile phone, a tablet computer, etc.) where the display real estate is relatively limited.

The discussion above is merely provided for general background information and is not intended to be used as an aid in determining the scope of the claimed subject matter.

### SUMMARY

A user interaction is detected, selecting a unit with a user input mechanism. A current context is identified and a set of property categories is identified. The set of property categories is arranged in an order. Properties for the selected unit, and corresponding attributes for those properties, are retrieved, categorized into the set of categories (based on the attributes and the context) and surfaced, in the order, for user interaction. Visual indicia can be displayed, identifying one or more categories that the properties belong to.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a property configuration and surfacing architecture.

FIG. 2 is a flow diagram illustrating one example of the operation of a property creation and configuration system.

FIGS. 3A-3F show examples of user interface displays.

FIGS. 4A and 4B (collectively referred to herein as FIG. 4) show a flow diagram illustrating one example of the operation of a property surfacing system and display system.

FIGS. 5A-5D show various examples of user interface displays.

FIG. 6 is a block diagram showing one example of the architecture shown in FIG. 1, deployed in a cloud computing architecture.

FIGS. 7-9 show various examples of mobile devices.

FIG. 10 is a block diagram of one example of a computing environment that can be deployed in the architectures of the previous figures.

### DETAILED DESCRIPTION

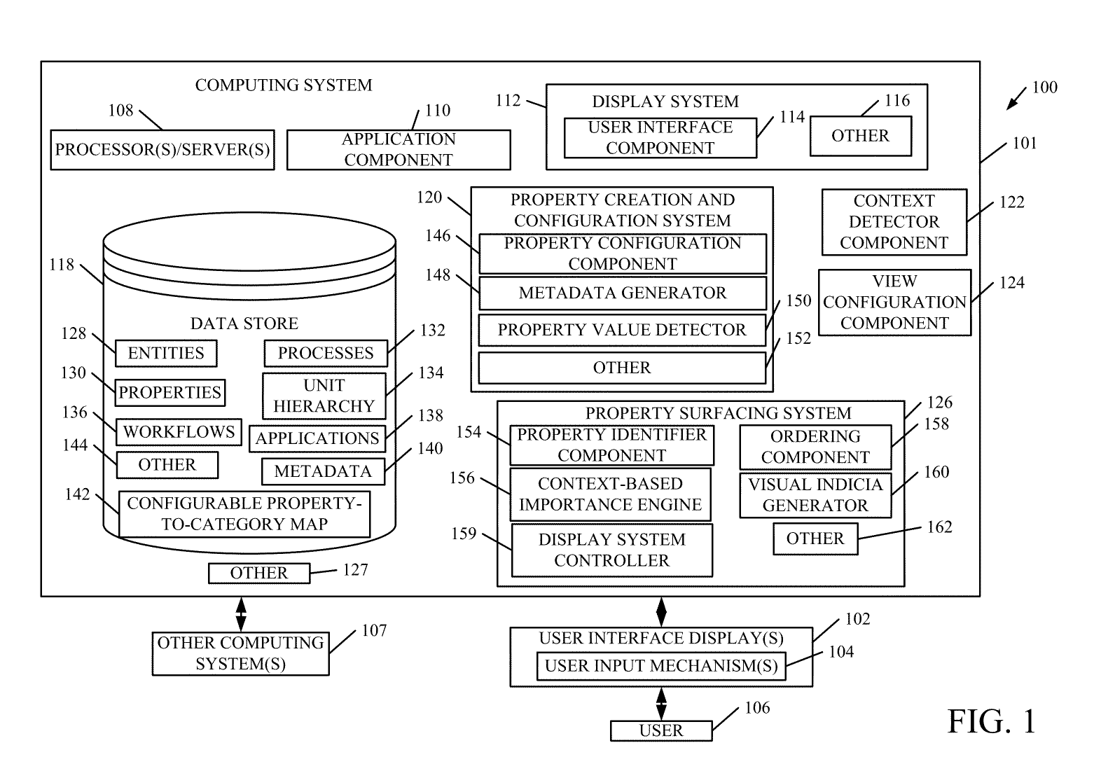

FIG. 1 is a block diagram of one example of a property configuration and surfacing architecture 100. Architecture 100 includes computing system 101 that is shown generating user interface displays 102 with user input mechanisms 104 for interaction by user 106. User 106 illustratively interacts with user input mechanisms 104 in order to control and manipulate various parts of computing system 101. Architecture 100 is also shown communicatively coupled to other computing systems 107.

In the example shown in FIG. 1, computing system 101 illustratively includes processors or servers 108, application component 110, display system 112 (which, itself, includes user interface component 114 and it can include other items 116), data store 118, property creation and configuration system 120, context detector component 122, view configuration component 124, property surfacing system 126, and it can include other items 127. Data store 118, itself, illustratively includes one or more entities 128 which can be defined by, or include, properties 130. Data store 118 can also illustratively include processes 132, a unit hierarchy 134, workflows 136, applications 138, other metadata 140, a configurable (and context-based) property-to-category map 142, and it can include other items 144.

Property creation and configuration system 120 illustratively includes property configuration component 146, metadata generator 148, property value detector 150, and it can include other items 152. Property surfacing system 126 illustratively includes property identifier component 154, context-based importance engine 156, ordering component 158, display system controller 159, visual indicia generator 160, and it can include other items 162. Before describing the operation of architecture 100 in more detail, a brief description of a number of the items in architecture 100, and their operation, will first be provided by way of overview.

Entities 128 can illustratively represent physical units or physical items, or other items within computing system 101. For instance, when an organization that uses computing system 101 manufactures or sells products, then entities 128 can represent the products. Properties 130 can illustratively represent physical (or other) characteristics of the products. By way of example, if a particular entity 128 represents a tablet computer, then the properties 130 (which can also be defined in metadata 140) illustratively represent the color of the tablet computer, the software installed on the tablet computer, the battery size, the screen size, among a whole host of other physical characteristics of the product. Of course, where the entity 128 represents a different unit, then the properties 130 illustratively represent the characteristics of that particular unit.

Unit hierarchy 134 illustratively represents a hierarchy of the various units or families of units represented in computing system 101, for the purposes of organizing them. By way of example, the unit hierarchy 134 may represent electronic units under a hierarchy, such as the one below:

Electronics->Computers->Tablet Computers->Brand X Tablet Computers->Brand X, Model Y, Tablet Computers . . . .

It can thus be seen that the nodes to the left in the above hierarchy are ancestor nodes to those on the right. The nodes to the right are descendent nodes relative to the nodes on the left. In an example where computing system 101 is used by a relatively large organization, such as an enterprise organization, computing system 101 may have thousands of different unit hierarchies to classify all of the various products of the organization.

User 106 or other computing system 107 may wish to obtain access to entities 128, and the corresponding properties 130, in a variety of different contexts. For instance, when another computing system 107 is an inventory system, then it may wish to obtain the entities 128 and properties 130 in the context of an inventory system. When user 106 is a sales user, then user 106 may wish to obtain access to entities 128 and the corresponding properties 130, in a sales context. When user 106 or other computing system 107 is a manufacturing user or system, then that particular user or system may wish to access entities 128 and corresponding properties 130, in the context of manufacturing. It may be that, based upon the context, different properties 130 have a different importance level (for their corresponding unit) than in another context. Therefore, in one example, configurable property-to-category map 142 identifies an ordering of properties 130 indicating how important they are in different contexts. In one example, the properties are grouped into different categories, based on their attributes and the current context, using map 142. Those categories are then surfaced for a user 106 or another computing system 107. Therefore, if they are to be surfaced in the sales context, the properties 130 may be ordered in a particular way. However, if they are to be surfaced in an inventory or manufacturing context, then they may be ordered in a different way.

Application component 110 illustratively runs applications 130 that may perform processes 132, workflows 136, etc. It may also access unit hierarchy 134 and operate on entities 128, metadata 140, or other records.

Property creation and configuration system 110 illustratively generates user interface displays, with user input mechanisms, that user 106 can interact with. For instance, when property receiving component 146 detects user interaction with some of the user input mechanisms, this may indicate that user 106 is providing inputs to configure a set of properties for a given entity 128. The user may be adding properties, or attributes on properties, specifying default values for attributes of the properties, deleting properties or attributes, changing a categorization of the properties, etc. In response, metadata generator 148 illustratively generates metadata 140 for properties 130, based upon the user configuration inputs. When the user is specifying a value for a property (such as a default value), property value detector 150 detects that and saves it for the particular property 130 being configured.

During runtime, property surfacing system 126 detects user interactions, (or interactions by other computing systems 107) indicating that certain properties are to be surfaced. Context-based importance engine 156 accesses context detector component 122, which detects a particular context in which the properties are to be surfaced. Context-based importance engine 156 then accesses the configurable property-to-category map 142 to identify a property order, in which the properties are to be surfaced based upon the current context. Property identifier component 154 then identifies the set of properties 130 that are to be surfaced, and categorizes them, and ordering component 158 orders those properties, for surfacing, based upon their particular attributes. Visual indicia generator 160 can illustratively generate visual indicia indicating an importance level, a categorization, or another characteristic of the properties or property attributes.

Display system controller 159 then controls display system 112, and user interface component 114, to surface the properties for user 106 or other computing system 107, in the particular order, based upon the context in which they are accessed. This can be advantageous in a variety of different ways. For instance, certain entities may have a relatively lengthy list of properties. Therefore, displaying them all on a single user interface display 102, or a given display device, can be difficult. This may be exacerbated where the display device is one with relatively limited display real estate, such as on a mobile phone, a tablet computer, etc. By displaying the properties 130 in a specific order, based upon their importance in the context in which they are accessed, property surfacing system 126 can place the most important properties, given the particular context in which they are being surfaced, at the top of the display. Therefore, a user 106 or other computing system 107 need not traverse a lengthy list of properties in order to access the most important properties, given their context. This not only improves the efficiency of the operation of computing system 101 relative to user 106 and other computing systems 107, but it also improves the performance of system 101, itself. For instance, because system 126 controls system 112 to display the properties in a desired order, it is more likely that user 106 or other computing systems 107 can access the properties from a single display, even without scrolling the display. This reduces rendering overhead. Similarly, it also may advantageously result in fewer searches being conducted by user 106 and computing system 107 for relevant properties. This can reduce network traffic and round trips to data store 118. This further reduces computing and memory overhead as well as rendering overhead.

View configuration component 124 can also illustratively generate user interface displays, with user input mechanisms, so that user 106 can configure the view of the properties. For instance, it may allow the user to scroll through a list of properties, to modify the size of the property display, etc.

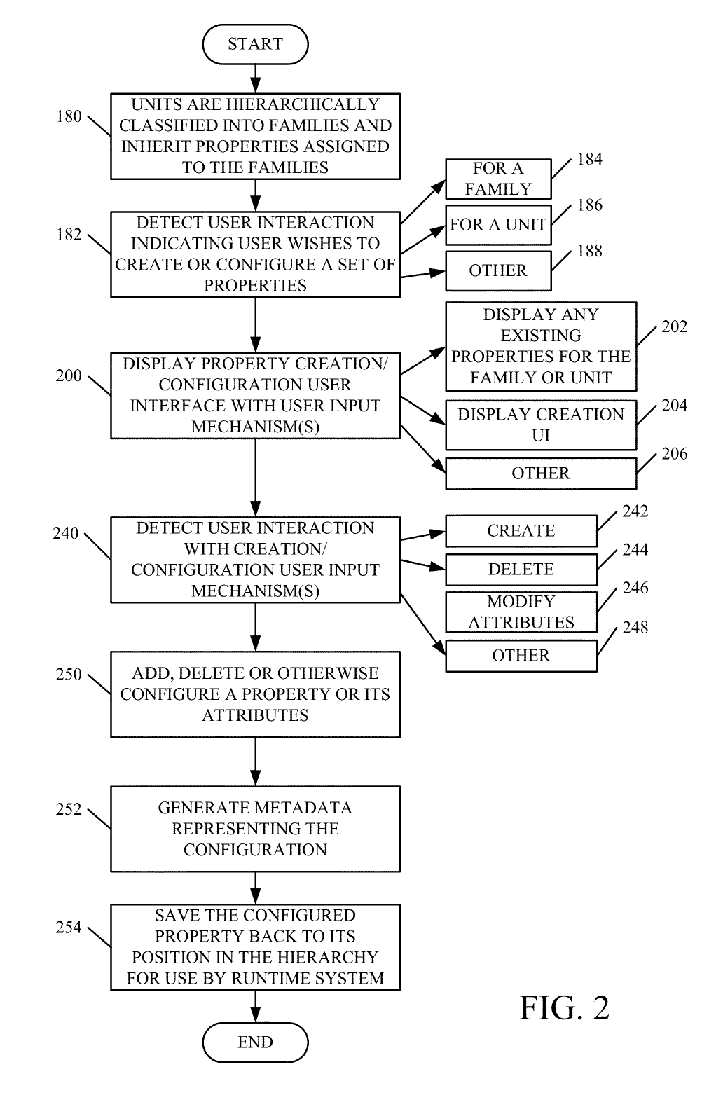

FIG. 2 is a flow diagram illustrating one example of the operation of property creation and configuration system 120, in allowing a user 106 to configure (such as add, delete or modify) properties 130 for a given entity 128. It is first assumed that the units represented in computing system 101 (e.g., those represented by entities 128) are already hierarchically classified into a unit hierarchy 134. The unit hierarchy may have families of products (represented by ancestor nodes) and the families may have properties set at the family level. The descendent nodes (which may represent specific products) illustratively inherit properties from the ancestor nodes. Having units already arranged in this way, according to unit hierarchy 134, with property inheritance, is indicated by block 180 in FIG. 2.

Display system 112 illustratively detects a user interaction indicating that the user wishes to create or otherwise configure a set of properties 130 in computing system 101. This is indicated by block 182. By way of example, it may be that user 106 wishes to configure a set of properties for a family of products in unit hierarchy 134. This is indicated by block 184. It may also be that user 106 wishes to configure a set of properties for a particular unit represented by a leaf node in unit hierarchy 134. This is indicated by block 186. It may be that user 106 wishes to perform other property configurations as well, and this is indicated by block 188.

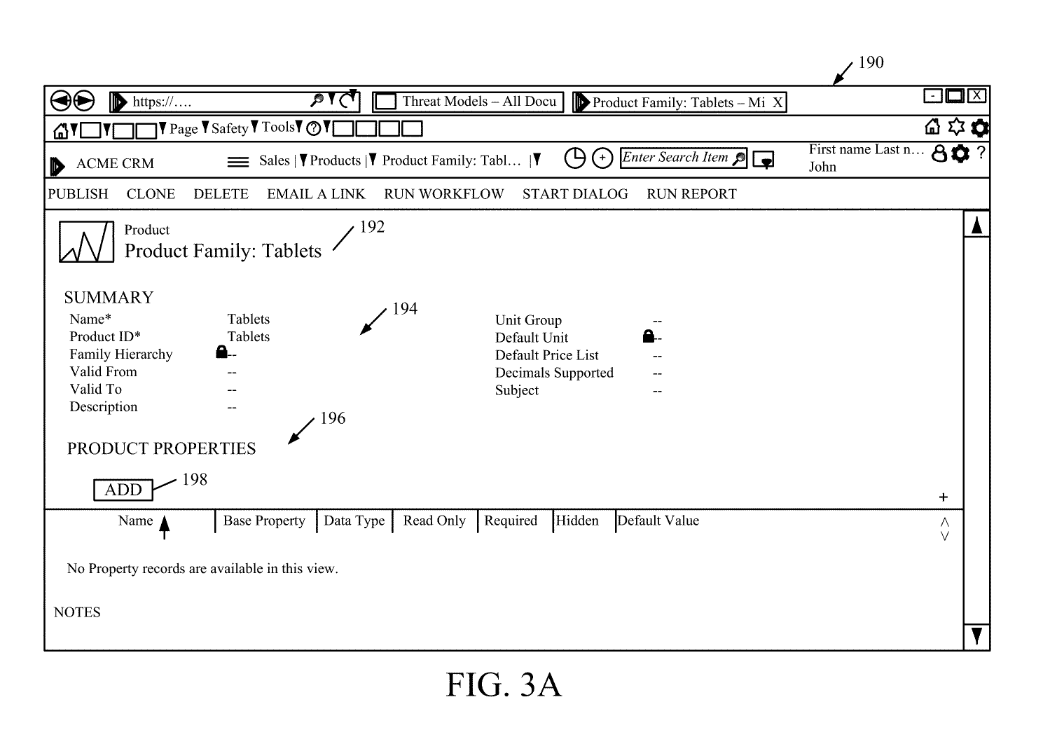

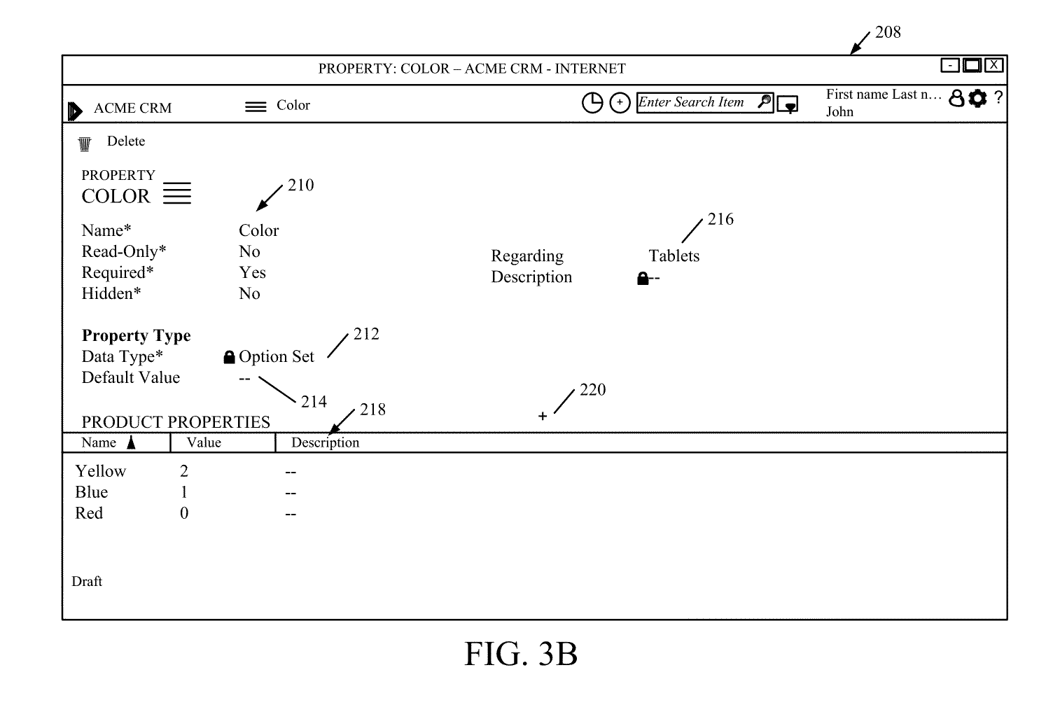

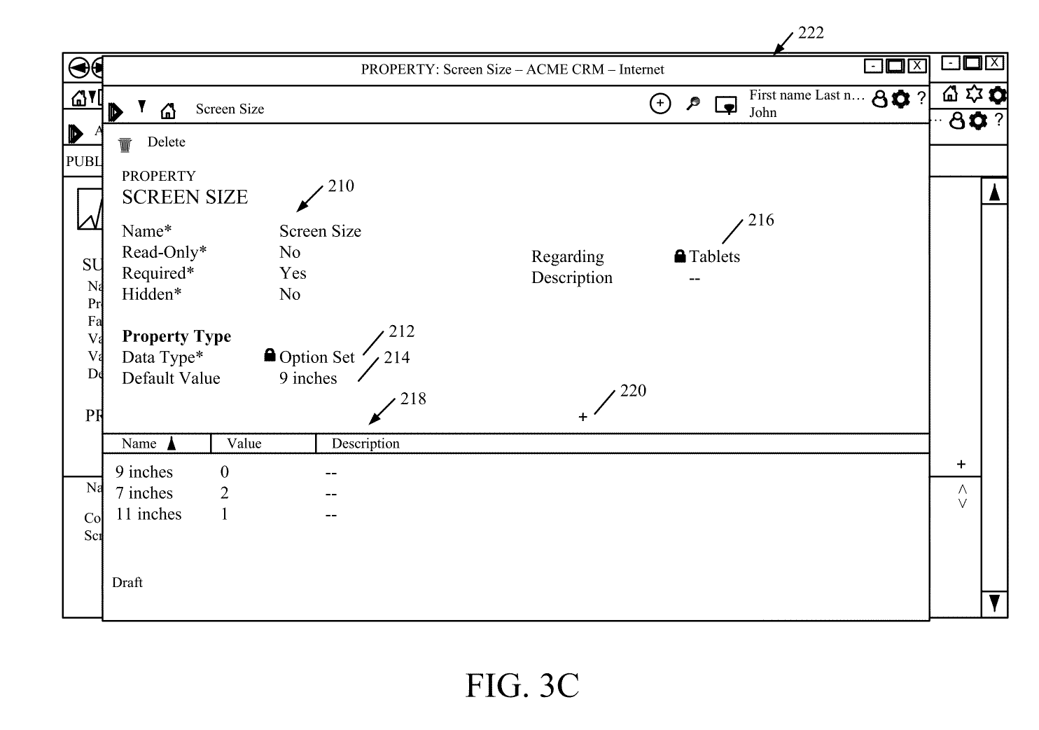

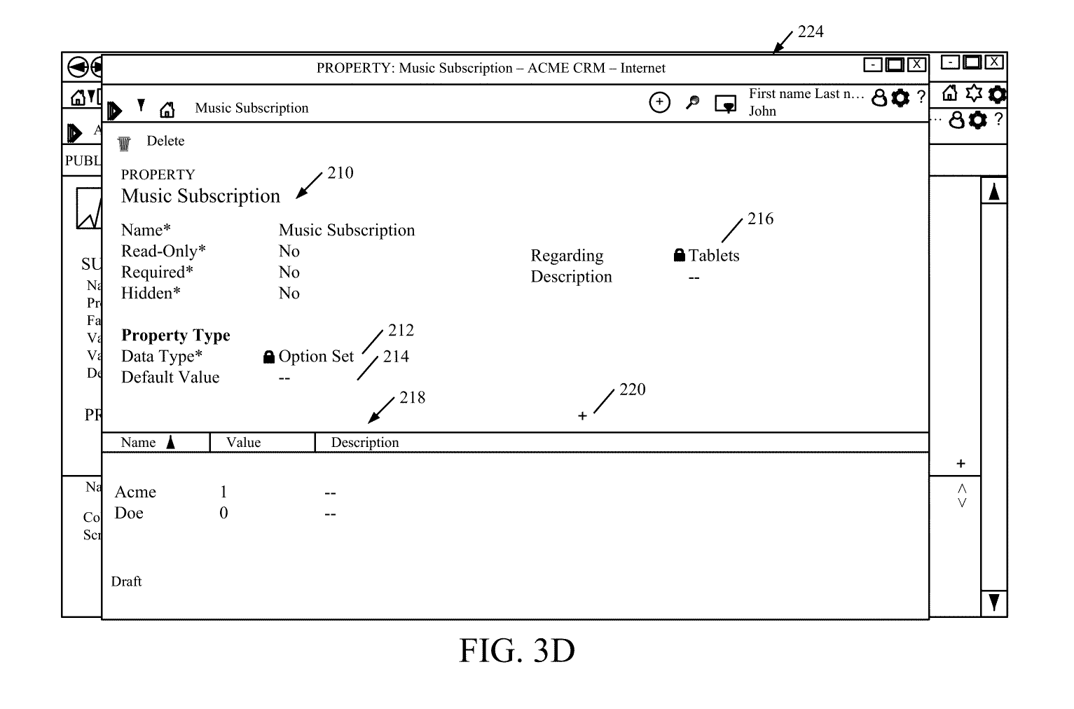

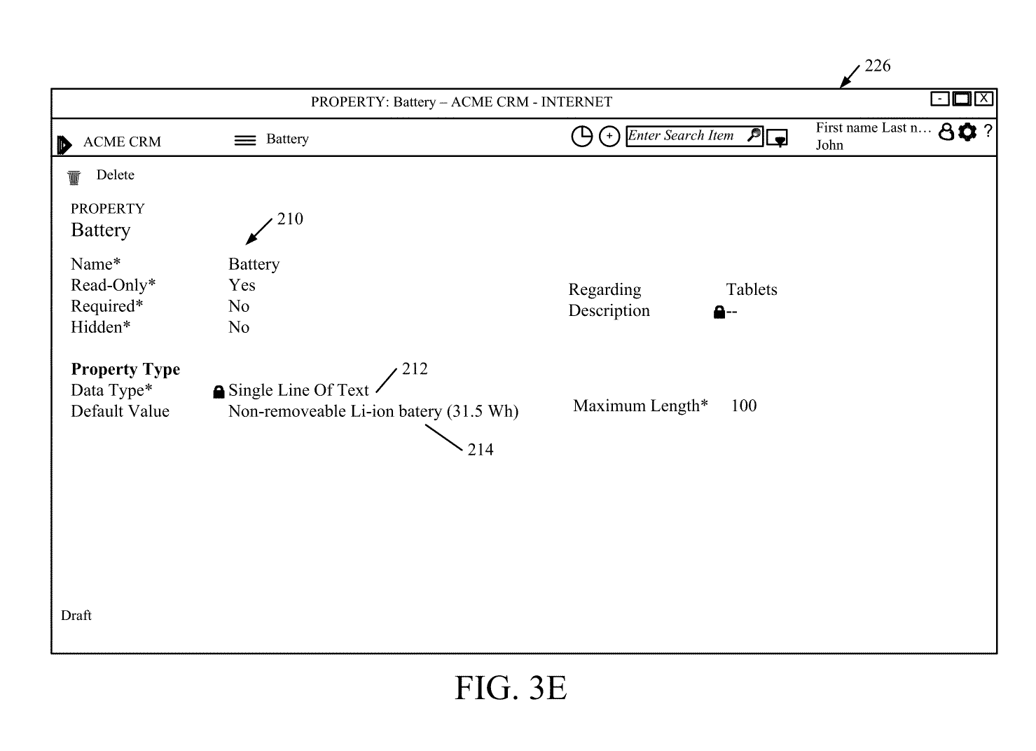

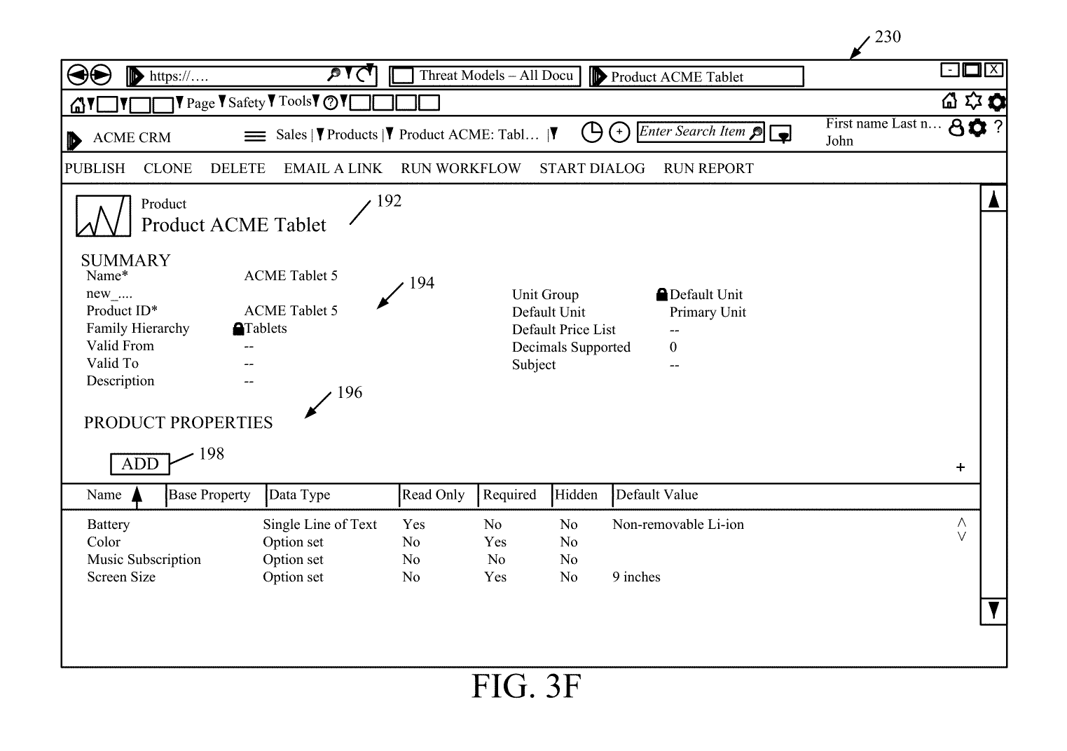

FIG. 3A shows one example of a user interface display 190 that illustrates this. User interface display 190 illustratively displays information that represents a product family within unit hierarchy 134. The particular product family is identified generally at 192, as “tablets”. The “tablets” node in unit hierarchy 134 is illustratively described or defined by a set of metadata 194. In the example shown in FIG. 3A, the metadata 194 includes a name, product identifier, family hierarchy, validation dates, a description, and a set of other values, such as a unit group, a default group, a default price list, an indication as to whether decimals are supported, a subject indicator, etc. Of course, this is only an example of the type of metadata that can represent the “tablets” family in unit hierarchy 134.

User interface display 190 also shows that the “tablets” family in unit hierarchy 134 can have a set of properties 196 assigned to it. In the example shown in FIG. 3A, no properties have yet been assigned to that tablet family node. However, display 190 also illustratively includes a user input mechanism, such as add button 198, that allows the user to add one or more properties to the “tablet” family node in unit hierarchy 134.

Returning again to the flow diagram of FIG. 2, when the user actuates a user input mechanism indicating that the user wishes to configure a set of properties (such as by actuating add button 198 in FIG. 3A), property configuration component 146 in property creation and configuration system 120 illustratively generates a user interface display that displays a property creation/configuration user interface, with user input mechanisms that can be actuated by the user in order to create or otherwise configure a set of properties. This is indicated by block 200 in FIG. 2. For instance, the display can display any existing properties that have already been assigned to the family or unit selected by the user for configuration. This is indicated by block 202. It can also display a creation user interface that allows the user to create properties (or add properties). This is indicated by block 204. It can generate a property creation/configuration user interface display in other ways as well, and this is indicated by block 206. FIGS. 3B-3E show various examples of this.

It will be noted that, in the examples shown in these Figures, the user illustratively configures properties and attributes for all contexts at once. However, in another example, the user can configure the properties and attributes differently for different contexts. In such an example, property configuration component 146 generates a user interface display with a user input mechanism that allows a user to specify a context that the configuration corresponds to. For instance, in one context, a property value may be required and have no default value. In another context, the same property may be optional and have a default value specified for it, etc.

FIG. 3B, shows an example of a user interface display 208 that allows the user to create or modify or otherwise configure a property. In display 208, the user has selected the “color” property for configuration. The “color” property is represented in display 208 by a set of attributes 210. The attributes illustratively include the name of the property, whether the property is a read only property, whether it is a required property in a given context, or whether it is hidden or visible.

Attributes 210 also indicate whether the property can have values that are chosen from a set of options. This is indicated generally at 212. It can also indicate whether the property has a pre-defined default value, and what that default value is. This is indicated generally at 214. Attributes 210 also illustratively indicate a family to which the property belongs, and this is indicated generally at 216. It can also include a description of the property or family.

Further, where the attributes shown generally at 212 indicate that the value of the given property can be chosen from a set of options, then attributes 210 also illustratively include an option set shown generally at 218, which can be displayed when a user wishes to enter a value for the property. In the specific example shown in FIG. 3B, the “color” property can be set to a value chosen from one of three options. The options are yellow, blue and red. When a user enters the value 2, this corresponds to the color having a value of yellow. When the user enters the value 1, this corresponds to blue, and when the user enters the value 0, this corresponds to the color red. User interface display 208 also includes an add user input mechanism 220 that allows the user to add attributes or options. In the example shown in FIG. 3B, when the user is configuring the “color” property, the user can illustratively enter values to define the color property, for all of the attributes 210-218. Thus, the user can define the color property to include a particular name, and to indicate whether it is read only, required, hidden, etc. The user can also specify the option set and define values that are to be chosen from that set, and the user can specify a default value.

FIG. 3C shows another example of a user interface display 222 that allows the user to configure a property. In the example shown in FIG. 3C, the user has configured the “screen size” property to be read only, required in a given context, and to be visible. The user has also indicated at 212 that the value for the property is to be chosen from an option set and the default value for the “screen size” property is to be “9 inches” as shown generally at 214. The option set 218 includes option values that can be selected, such as 9 inches, 7 inches, and 11 inches. All of these attributes are illustratively configurable by the user. The user can also actuate user input mechanism 220 to add other attributes, other options, etc.

FIG. 3D shows yet another example of a user interface display 224. Display 224 is similar to displays 208 and 222, and similar items are similarly numbered. However, it can be seen in FIG. 3D that the user is now configuring a property named “music subscription”. This may indicate, for instance, whether a particular tablet computer comes with a music subscription when it is shipped from the manufacturer. Attributes 210 illustratively indicate that the “music subscription” property is not read only, is optional (or not required) and is visible. The attributes indicate generally at 212 that the value for the property is to be chosen from an option set, and at 214 that no default value is provided. The option set configured by the user is indicated generally at 218. Again, the user can add additional properties or options by actuating user input mechanism 220.

FIG. 3E shows yet another example of a user interface display 226 that can be generated by property creation and configuration system 120. The attributes 210 in user interface display 226 indicate that the user is configuring a property named “battery”. The user has configured the “battery” property to be a read only property, not required and visible. The property is to be represented by a single line of text (as shown generally at 212), and it has a particular default value shown generally at 214.

In all of the examples discussed above, when the user enters configuration information to configure one or more attributes, metadata generator 148 in property creation and configuration system 120 illustratively generates corresponding metadata 140 to represent that particular configuration input. For instance, when the user provides a configuration input indicating that a particular property is required, then generator 148 generates metadata indicating that, in the relevant attribute. Metadata generator 148 then saves the metadata 140 back to data store 118 where it now represents the newly configured property, and where it is placed in (or otherwise related to) its proper position in unit hierarchy 134, so that it can be used by the runtime system in surfacing properties, applying inheritance of properties, etc.

FIG. 3F illustrates one example of inheritance of properties and attribute values through unit hierarchy 134. FIG. 3F shows one example of a user interface display 230, where the user has provided an input to display a product entity 128 for a particular brand of tablet computer (the ACME Tablet 5). It can be seen that the unit or product display shown in 230 has similar summary information 194 as that shown for a product family in FIG. 3A, except that the name and product ID are for the specific “ACME Tablet 5” product, and the family hierarchy indicates that the family is the “tablets” family. In addition, property section 198 now includes all of the properties that were previously defined for the “tables” family of products. This is because the “ACME Tablet 5” product corresponds to a descendent node of (or belongs to the family of) the “tablets” family node in unit hierarchy 134. Thus, the “ACME Tablet 5” product inherits the “battery”, “color”, “music subscription”, and “screen size” properties that were defined above with respect to FIGS. 3B-3E. Properties section 196 also illustrates a number of the different attribute values for each of those properties. For instance, it indicates the data type, whether the property is read only, whether it is required, whether it is hidden, and whether there is a default value (and if so, what that default value is).

Returning to the flow diagram of FIG. 2, as described above, property configuration component 146 illustratively detects user interaction with any of the creation/configuration user input mechanisms (some examples of which are described above with respect to FIGS. 3B-3E). This is indicated by block 240. As discussed, those user interactions can be to create a new property 242, to delete one 244, to modify attributes of a property 246, or to perform other configuration inputs 248.

Once the inputs are detected, then property configuration component 146 performs the actions indicated by those configuration inputs. This can include, for instance, adding a property or attribute, deleting one, or otherwise configuring or modifying a property or its attributes. This is indicated by block 250. Metadata generator 148 then generates metadata representing the configuration actions that were just taken. This is indicated by block 252.

System 120 then saves the configured property back to its position (or otherwise relates it to its position) in unit hierarchy 134, for use by the runtime system. This is indicated by block 254.

It should be noted that, in one example, when the user is configuring a property by setting its attribute values, some of the attribute values may be automatically set by property value detector 150. For instance, property value detector 150 may interface with an inventory computing system (representing by other computing systems 107), when the user is configuring a “battery” property. The inventory system may indicate that there are only certain types of batteries that are currently in inventory. Therefore, property value detector 150 may illustratively automatically define the option set for the “battery” property to include only the particular types of batteries that are available. The same can be done for substantially any property value or property attribute value.

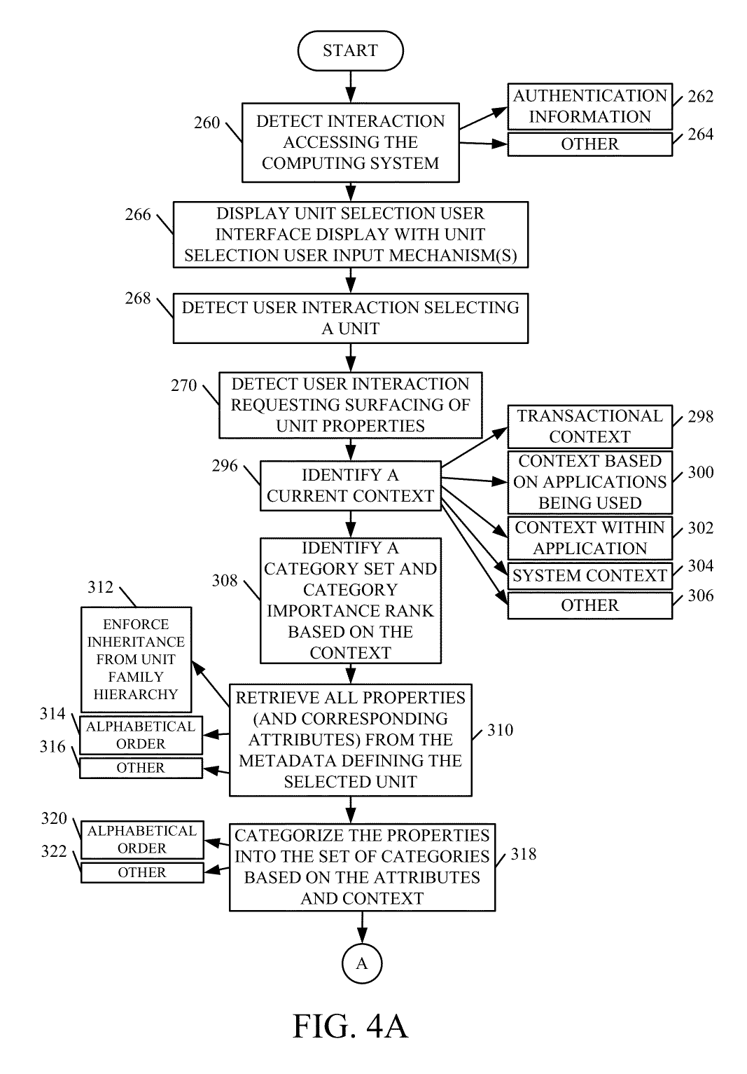

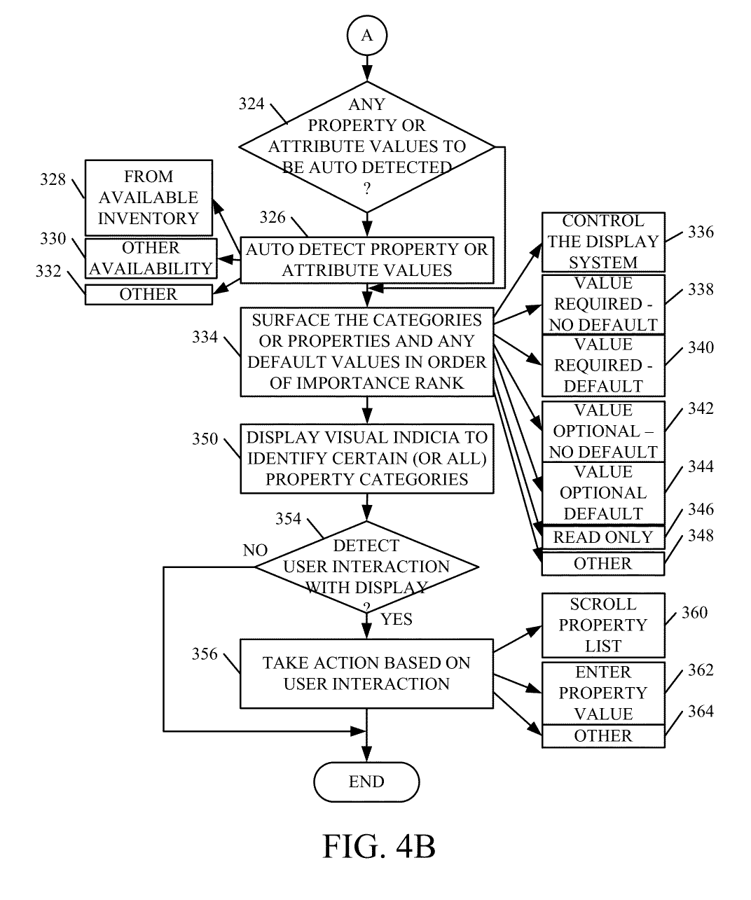

FIGS. 4A and 4B (collectively referred to herein as FIG. 4) show a flow diagram illustrating one example of the operation of property surfacing system 126 in surfacing properties during runtime, and in controlling display system 112 and user interface component 114, in generating displays representative of those properties. System 126 first detects a user interaction accessing computing system 101. This is indicated by block 260 in FIG. 4. For instance, user 106 or other computing systems 107 may provide authentication information 262. They may also provide interactions indicating that they wish to access properties from system 101 in other ways as well. This is indicated by block 264. For the rest of the discussion of FIG. 4, it will be assumed that user 106 is interacting with system 101 to have properties surfaced. It will be noted, however, that this could just as easily be performed by other computing systems 107 (either in automated fashion through application programming interfaces or other interfaces to system 101, etc.).

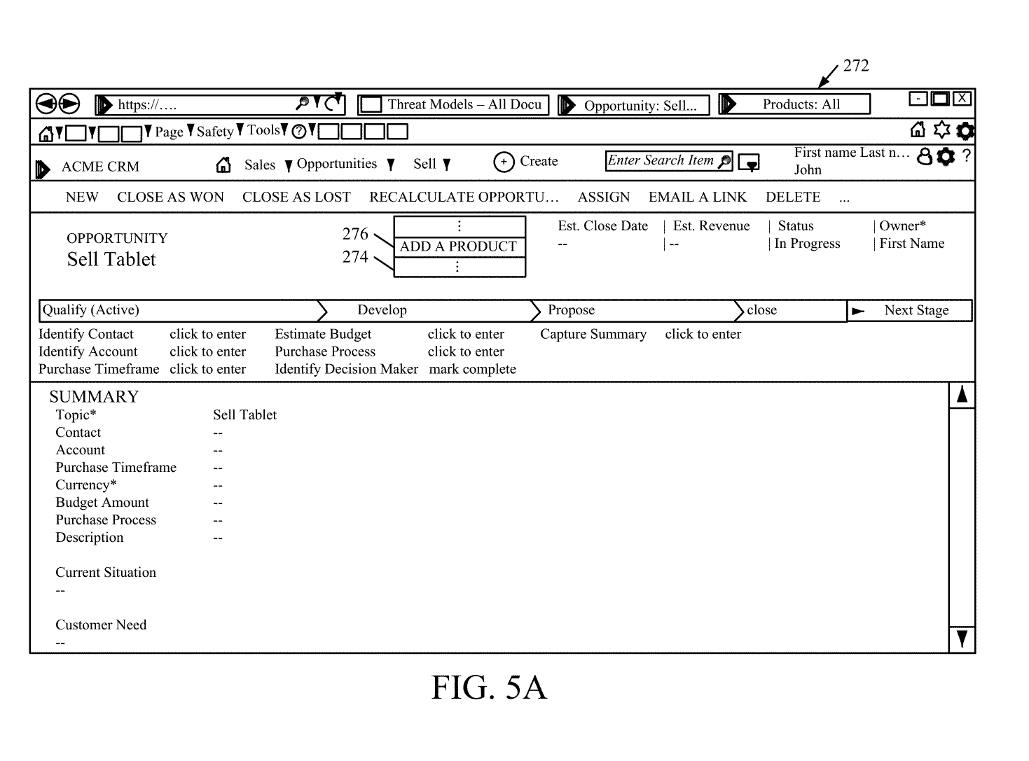

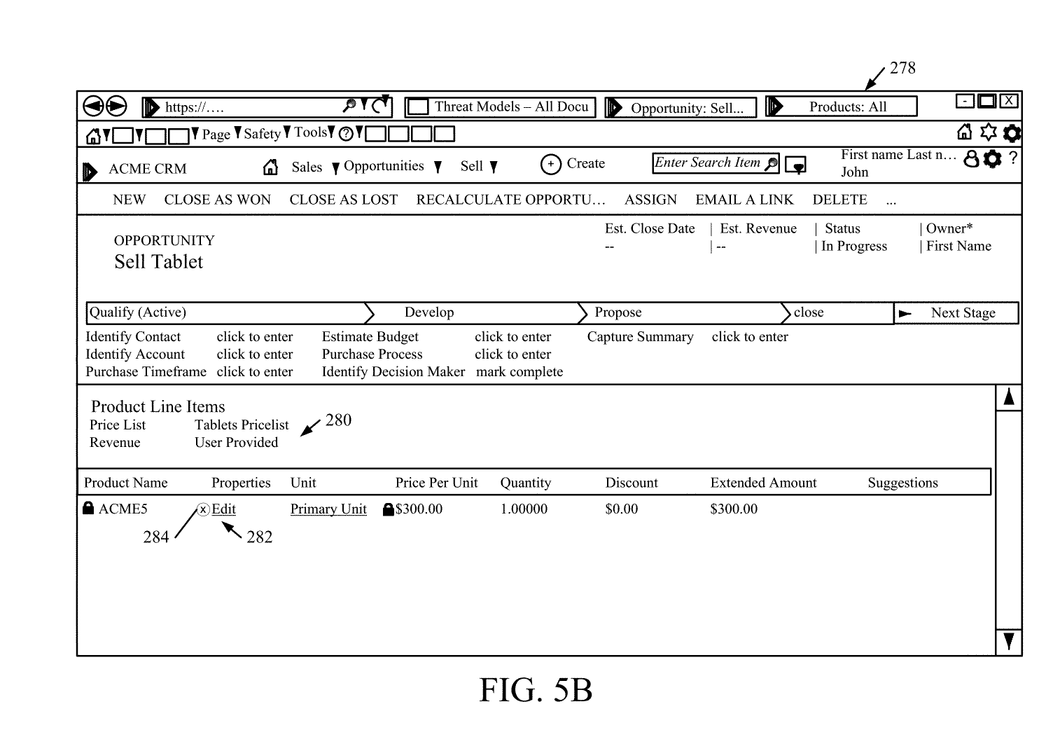

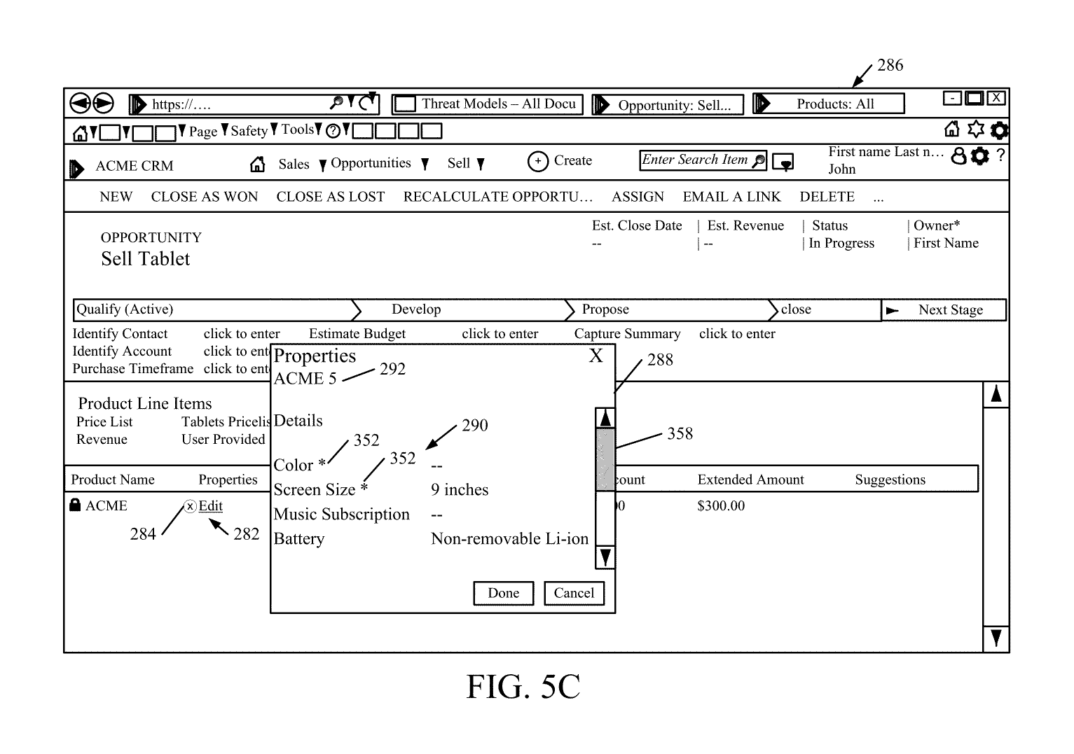

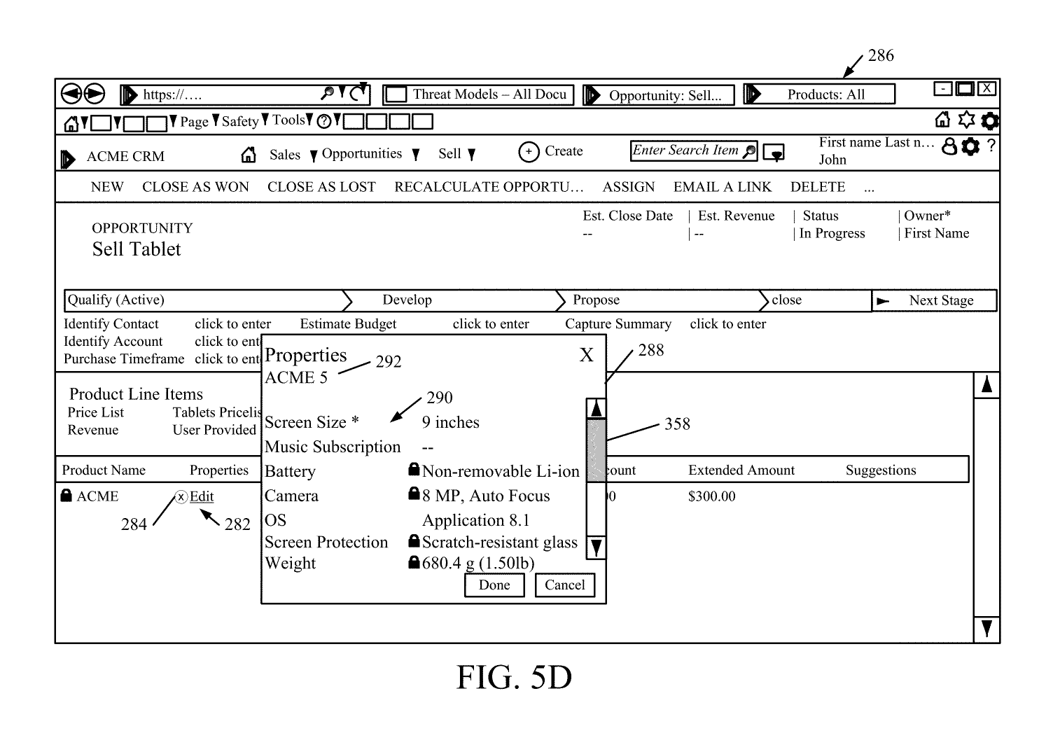

Display system 112 then displays a unit selection user interface display with unit selection user input mechanisms. This is indicated by block 266. For instance, the display may allow user 106 to select a product (or other unit) and see the description of that product, along with its properties, etc. Display system 112 then detects a user interaction selecting a unit for display. This is indicated by block 268. Display system 112 then detects a user interaction indicating that the user is requesting that the properties for the selected unit be surfaced for interaction by the user. This is indicated by block 270. FIGS. 5A and 5B show examples of user interface displays that indicate this.

FIG. 5A shows one example of a user interface display 272 that can be generated by an application 138 under the direction of application component 110. User interface display 272 illustratively represents a process 132 or workflow 136 that can be performed by computing system 101, under the direction of user 106. In performing the process 132 or workflow 136, system 101 may need inputs from user 106. Therefore, display system 112 may provide displays with user input mechanisms which allow user 106 to interact with system 101. User interface display 272 thus directs user 106 through a process in order to conduct a transaction (such as a sale) of a unit or product. In the example shown in FIG. 5A, the unit is a tablet computing device. Application component 110 can control display system 112 to include a drop down menu 274 that allows user 106 to specify a unit or product (such as described above with respect to block 268 in FIG. 4). When the user actuates user input mechanism 276, system 101 illustratively walks user 106 through a user experience where the user can input a specific product on which the transaction is to be conducted.

FIG. 5B shows that application component 110 has now generated a user interface display 278 and controlled display system 112 to display it for user 106. User interface display 278 now indicates that user 106 has provided a user input, through a suitable user input mechanism, specifying a unit or product as the “ACME 5” tablet computer. User interface display 278 illustratively includes a unit identification portion 280 that identifies the unit input (or selected) by the user. It can include a variety of information, such as the name of the product, its price, any discounts that apply, etc. It also illustratively includes a properties user input mechanism 282 that indicates that the ACME 5 product has a set of properties that correspond to it. In addition, it can provide a visual indicator 284 that indicates that certain properties are required (e.g., they must have values entered for them), in order for system 101 to perform the process, workflow or other transaction relative to the identified product. This indicates to the user that the user needs to enter values for such properties.

In one example, display element 282 is illustratively an actuatable link. When the user actuates it (such as by tapping it, clicking on it, etc.), this acts as the detected user interaction requesting surfacing of unit properties as described above with respect to block 270 in FIG. 4. In response, property surfacing system 126 identifies the properties that are to be surfaced for this particular product or unit and surfaces them. It then controls display system 112 and user interface component 114, to display the properties. One example of this is indicated by user interface display 286, shown in FIG. 5C. It can be seen that user interface display 286 includes a properties display section 288. Display section 288 illustratively displays the various properties 290 for the ACME 5 product identified generally at 292. It can be seen that the properties 290 include the “color” property, the “screen size” property, the “music subscription”, and the “battery” property discussed above with respect to the operation of configuration system 120.

Returning again to the flow diagram of FIG. 4, one way in which property surfacing system 126 identifies the properties and surfaces them will now be described. Recall that the system has already detected a user interaction selecting a unit (or product) and it has detected a user interaction indicating that the user wishes to view the properties for the selected unit or product. In one example, context detector component 122 first identifies the current context in which the user is requesting that the properties be surfaced. This is indicated by block 296. This can be a transactional context 298. For instance, if user 106 is attempting to access the properties to perform a given transaction, the transaction may determine the particular context for surfacing the properties.

The detected context may also be a context based upon the current application 110 being used. This is indicated by block 300. For instance, if the current application 110 is used to perform a given process or workflow, this may determine the particular context in which the properties are being surfaced.

The context may be a context within an application, as indicated by block 302. For instance, if the application is a manufacturing application, it may be accessing the properties in a context in which raw materials are being ordered for manufacturing. It may also access the properties in a context in which the manufactured products are being packaged and shipped. Thus, the particular context within an application, may determine the context within which the properties are being accessed as well. The context may also be a system context 304. For instance, the system context may be representative of a particular processing load under which system 101 is currently operating. It may also identify system characteristics, such as a screen size of a display device on which the properties will be rendered. Other system characteristics may define the context as well. Of course, the context may be defined in other ways and this is indicated by block 306.

Once the context is identified by component 122, context-based importance engine 156 then identifies a category set and a category importance rank based on that context. This is indicated by block 308. For instance, the attributes of a particular property may be used to categorize the property into one of a variety of different categories. Engine 156 can access context-to-ordering map 142 to identify the particular categories within which the properties are to be placed for surfacing in the present context. It can also use map 142 to identify an order of importance of the property categories in the present context. If the properties are being surfaced in a sales context, then the properties may be categorized in a different way based on their attributes and a first category of properties may be the most important. However, if the properties are being accessed in a manufacturing context, then the properties may be categorized in a second way based on their attributes and it may be that another set of properties are most important. Thus, engine 156 not only identifies the various categories into which the properties are to be placed, given the present context, but it thus obtains a rank order for those categories indicating how important they are in the present context. In another example, the rank order for the categories is the same in all contexts and it is the categorization of the properties into those categories that varies based on context. In yet another example, the categorization is also the same, based on the attributes, for all contexts.

Property identifier component 154 then accesses the entity 128 representing the selected product (or unit) and retrieves the properties 130 for that entity, along with the property attributes represented by metadata 140. This is indicated by block 310 in FIG. 4. In doing so, it illustratively enforces inheritance within unit hierarchy 134. This is indicated by block 312. It can retrieve the properties and attributes in alphabetical order, as indicated by block 314, or in other ways, as indicated by block 316.

Property identifier component 154 then places the properties in the categories identified by engine 156, based upon the property attributes. This is indicated by block 318. It can place the properties in the different categories in alphabetical order, as indicated by block 320, or in other ways, as indicated by block 322.

In one example, the properties 130 indicate whether they are to have values that are automatically detected and entered, or whether they need to be entered in other ways. For instance, it may be that the “screen size” property has an option set of values that are to be determined based upon what is currently in stock. Therefore, component 154 can access other computing systems 107 (such as inventory computing systems, etc.) to determine the various screen sizes that are currently in stock for the ACME 5 tablet computer. It can then populate the option set attribute for the “screen size” property with only those screen sizes that are currently in stock. Thus, when user 106 sells an ACME 5 tablet computer, user 106 can only sell one that has a screen size that is currently available. Determining whether any of the property or attribute values are to be automatically detected is indicated by block 324. If so, automatically detecting the property or attribute values is indicated by block 326. Detecting them from available inventory is indicated by block 328. Detecting them based on other availability criteria or in other ways is indicated by blocks 330 and 332, respectively.

Display system controller 159 in surfacing component 126 then controls display system 112 and user interface component 114 to surface the categories of properties, and any default values, in the order identified by engine 156. In doing so, ordering component 158 orders the categories according to the specified order, and orders the properties and attributes within the categories as well. They are ordered according to the importance rank for the present context. This is indicated by block 334. Controlling the display system to surface the properties is indicated by block 336.

In one example, the categories can include a category where a property value is required in the present context, and no default value is provided. This is indicated by block 328. Another category can include a property that has a required value, in the present context, but where a default value is also provided. This is indicated by block 340. Another category may include a property whose value is optional in the present context, and which has no default value. This is indicated by block 342. Another category may include a property that has an optional value in the present context, but where a default value is provided. This is indicated by block 344. Another category may include a read only category, such as one that is intended to provide information to the user, but where no value can be changed. This is indicated by block 346. Of course, there can be other categories as well, as indicated by block 348.

By placing the properties in these categories based on their attributes, and by surfacing the properties, in this specified order, this can result in improved efficiency not only for system 101, but for user 106 and other computing systems 107, that are accessing the properties. By way of example, if the particular context is within a workflow or process, and the workflow or process cannot be completed without properties with required values having values entered for them, then this category of properties (where a value is required and no default value is provided) may be a most important category in this context. With the present system, this category of properties will advantageously be identified and displayed first (e.g., higher up) on the property display portion (such as display portion 288 shown in FIG. 5C). This can especially help on small screen devices. The category of properties where a value is required, but a default value is provided may be the next most important, and properties in that category can be identified and displayed next on the property display portion 288. Where the values are optional without default values, or optional with default values, or read only, these may be properties that are less important, and they can be identified and displayed (in that order) lower down in the property display portion 288.

A user can advantageously access the most important properties, given a present context, because they will be surfaced at the top of the property display. This improves user efficiency. In addition, it may be that the user can access all important properties without ever having to scroll the property display, thus reduces computing and memory overhead need for rendering. Further, because the user need not search for important properties, this can reduce round trips to data store 118, reduce network traffic, increase the performance of the system, etc.

In one example, visual indicia generator 160 can also display visual indicia that identify some or all of the categories into which the properties fall. This is indicated by block 350 in FIG. 4. For instance, as indicated in FIG. 5C, some properties are marked with asterisks 352. This may indicate that the properties have required values. Of course, the properties can be displayed with a wide variety of other visual indicia, such as color, boldness values, font differences, etc., or they can be displayed in blinking patterns, or in a wide variety of other ways, that visually indicate a category to which any given property belongs.

Also, in one example, the user 106 can illustratively interact with the property display portion 288. This is indicated by block 354 in the flow diagram of FIG. 4. If the user does this, then the appropriate component or system within computing system 101 takes the appropriate action. This is indicated by block 356. For instance, in one example, property display portion 288 shown in FIG. 5C illustratively displays too many properties to have them all be displayed on property display portion 288. Therefore, display portion 288 is provided with a scroll bar 358. One user interaction with display portion 288 may thus be to scroll the display using scroll bar 358. This is indicated by block 360 in the flow diagram on FIG. 4. FIG. 5D shows user interface display 286, that is similar to that shown in FIG. 5C, and similar items are similarly numbered. However, it can be seen in FIG. 5D that the user has now scrolled the property display portion 288 to view additional properties 290 for the ACME 5 tablet computer. It can be seen that the properties displayed toward the bottom of property display portion 288 are not required, and all have default values already entered for them. Thus, these may be the lowest importance properties with respect to the context in which the properties are being surfaced.

Another user interaction with property display portion 288 may be that the user enters a property value where one is permitted or needed. This is indicated by block 362. For instance, the user may enter a value for the “color” property or it may change the default value for the “screen size” property, etc. Of course, the user can interact with property display portion 288 in other ways. This is indicated by block 364.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

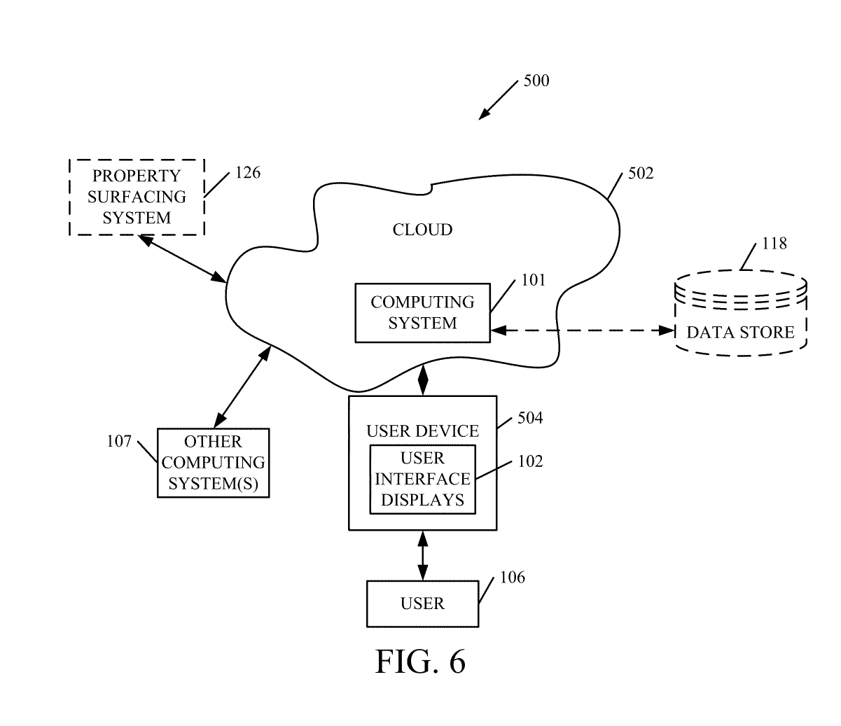

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 6, some items are similar to those shown in FIG. 1 and they are similarly numbered. FIG. 6 specifically shows that computing system 101 can be located in cloud 502 (which can be public, private, or a combination where portions are public while others are private). Therefore, user 106 can use a user device 504 to access those systems through cloud 502.

FIG. 6 also depicts another example of a cloud architecture. FIG. 6 shows that it is also contemplated that some elements of system 101 can be disposed in cloud 502 while others are not. By way of example, data store 118 can be disposed outside of cloud 502, and accessed through cloud 502. In another example, property surfacing system 126 can also be outside of cloud 502. Other items can be outside cloud 502 as well. Regardless of where they are located, they can be accessed directly by device 504, or other computing system 107 through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

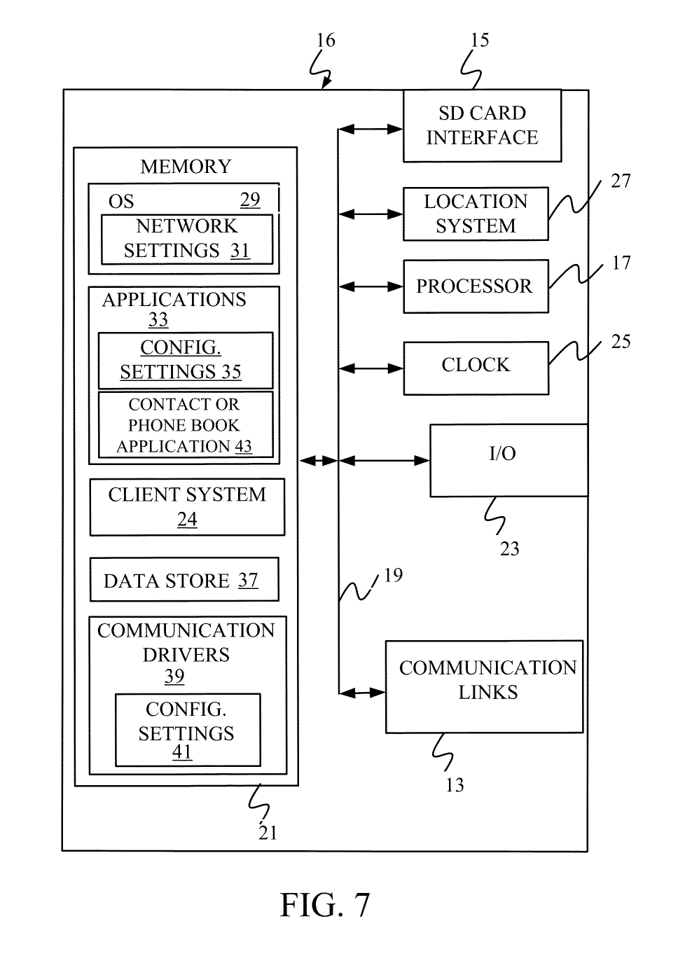

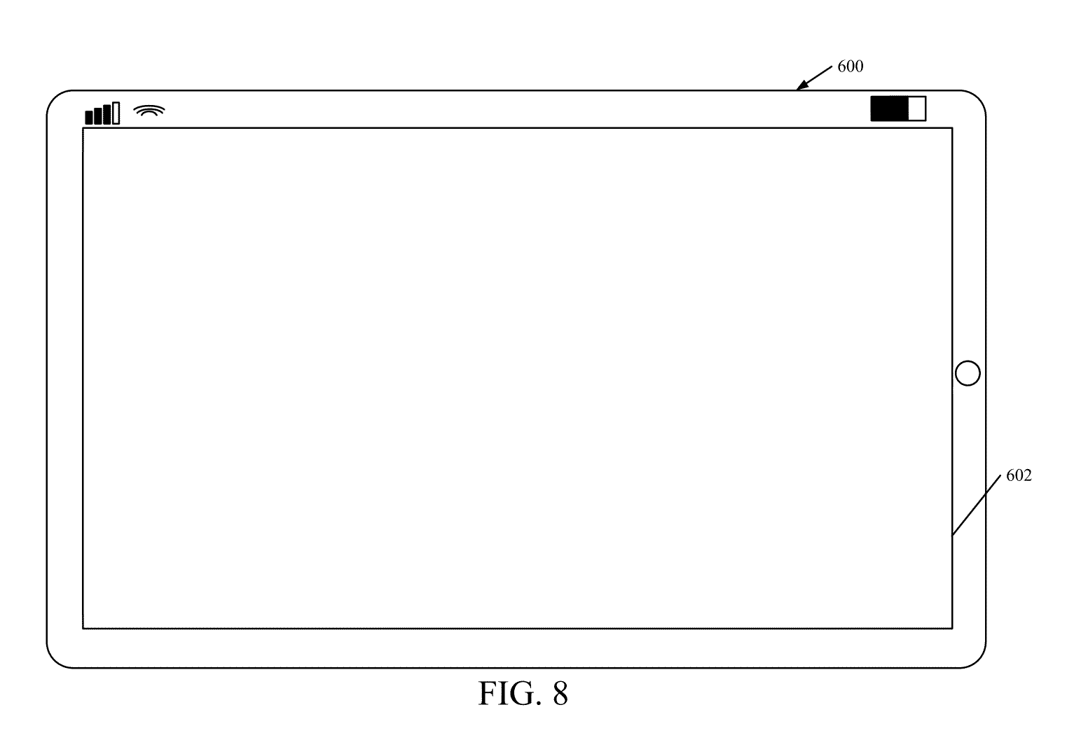

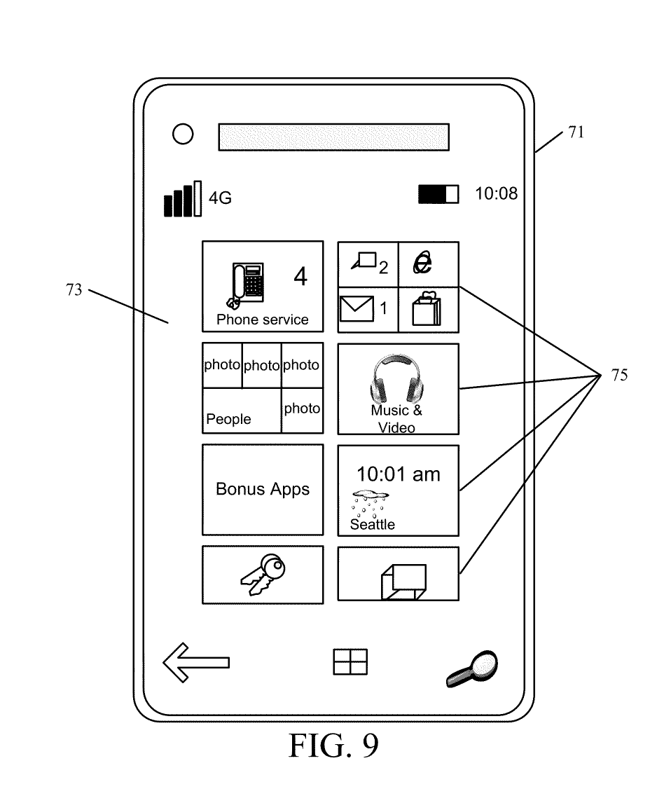

FIG. 7 is a simplified block diagram of one illustrative example of a handheld or mobile computing device that can be used as a user's or client's hand held device 16, in which the present system (or parts of it) can be deployed. FIGS. 8-9 are examples of handheld or mobile devices.

FIG. 7 provides a general block diagram of the components of a client device 16 that can run components of system 101 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 108 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of system 101. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one example in which device 16 is a tablet computer 600. In FIG. 8, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can also be used. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some examples, the phone also includes a Secure Digital (SD) card slot that accepts a SD card.

The mobile device can also be a personal digital assistant (PDA) or a multimedia player or a tablet computing device, etc. (hereinafter referred to as a PDA). The PDA includes an inductive screen that senses the position of a stylus (or other pointers, such as a user's finger) when the stylus is positioned over the screen. This allows the user to select, highlight, and move items on the screen as well as draw and write. The PDA also includes a number of user input keys or buttons which allow the user to scroll through menu options or other display options which are displayed on the display, and allow the user to change applications or select user input functions, without contacting the display. The PDA can also include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 9 shows that the phone can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

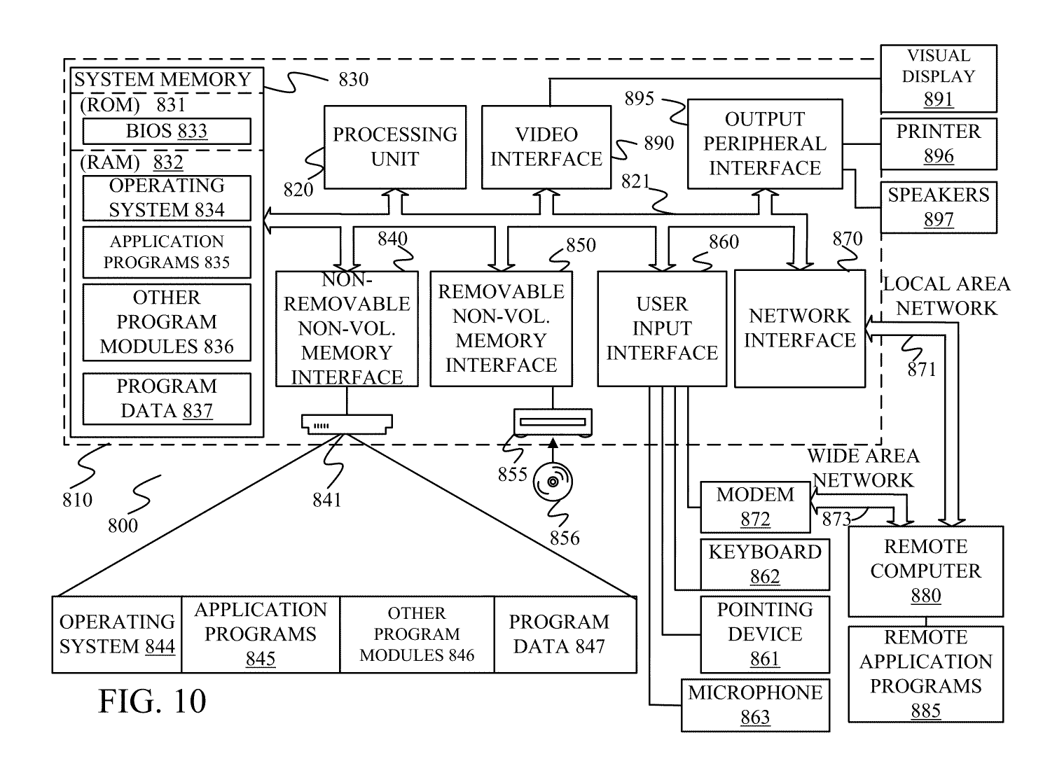

FIG. 10 is one embodiment of a computing environment in which architecture 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 108), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a display system that generates user interface displays;

a property identifier component that detects a user access interaction to access properties corresponding to a selected unit and that obtains the properties and corresponding attributes and categorizes the properties into a set of categories based on the corresponding attributes and based on a context in which the user access interaction is detected;

an ordering component that orders the properties in the categories in the set of categories and orders the categories into a category order; and

a display system controller that generates a user interface property display and that controls the display system to surface the properties on the user interface property display by displaying the categories of properties in the category order.

Example 2 is the computing system of any or all previous examples wherein the property identifier categorizes the properties into the set of categories, wherein the set of categories comprises:

a first category in which a property value is required for the context and no default value is provided for the property; and

a second category in which a property value is required for the context and a default value is provided for the property.

Example 3 is the computing system of any or all previous examples wherein the property identifier categorizes the properties into the set of categories, wherein the set of categories comprises:

a third category in which a property value is optional for the context and no default value is provided for the property;

a fourth category in which a property value is optional for the context and a default value is provided for the property.

Example 4 is the computing system of any or all previous examples wherein the ordering component orders the categories into the category order by placing the categories in order from the first category to the fourth category.

Example 5 is the computing system of any or all previous examples wherein the property identifier categorizes the properties into the set of categories wherein the set of categories includes a fifth category that has a read only value.

Example 6 is the computing system of any or all previous examples wherein the ordering component orders the properties alphabetically within each category.

Example 7 is the computing system of any or all previous examples and further comprising:

a visual indicia generator that generates visual category indicia on the user interface property display, the visual category indicia being indicative of which of the categories a given property belongs to.

Example 8 is the computing system of any or all previous examples and further comprising:

a context detector component that detects the context in response to the user access interaction.

Example 9 is the computing system of any or all previous examples wherein the context detector detects the context based on at least one of an application through which the user access interaction is detected and a computing system context when the user access interaction is detected.

Example 10 is the computing system of any or all previous examples and further comprising:

a context-based importance engine that identifies the category order based on the context detected by the context detector.

Example 11 is the computing system of any or all previous examples and further comprising a context-to-ordering map that maps which properties are in which categories, based on the corresponding attributes, in a given context and wherein the property identifier categorizes the properties by accessing the configurable context-to-ordering map.

Example 12 is the computing system of any or all previous examples wherein units are organized based on a unit hierarchy, with ancestor nodes and descendent nodes, in the computing system and further comprising:

a property configuration system detects user interactions assigning properties and corresponding attributes to the ancestor nodes and descendent nodes and wherein descendent nodes inherit properties assigned to its ancestor nodes.

Example 13 is the computing system of any or all previous examples wherein the property configuration system comprises:

a property configuration component that detects user configuration inputs indicative of user configuration of attributes on a corresponding property of a given unit; and

a metadata generator that generates metadata for the corresponding property, indicative of the configuration of the attributes.

Example 14 is a computer implemented method, comprising:

detecting a user access interaction to access properties corresponding to a selected unit represented in a computing system, the properties representing physical characteristics of the selected unit;

detecting a context in which the user access interaction is detected;

obtaining the properties and corresponding attributes corresponding to the selected unit;

categorizing the properties into a set of categories based on the corresponding attributes and based on the detected context in which the user access interaction is detected;

ordering the categories into a category order; and

controlling a display system to surface the properties on a user interface property display by displaying the categories of properties in the category order.

Example 15 is the computer implemented method of any or all previous examples wherein controlling the display system comprises:

controlling the display system to surface the properties on a user interface property display by displaying the categories of properties in the category order by: displaying a first category in which a property value is required for the context and no default value is provided for the property;

displaying, after the first category, a second category in which a property value is required for the context and a default value is provided for the property;

displaying, after the second category, a third category in which a property value is optional for the context and no default value is provided for the property; and

displaying, after the third category, a fourth category in which a property value is optional for the context and a default value is provided for the property.

Example 16 is the computer implemented method of any or all previous examples and further comprising:

detecting user assignment interactions assigning properties and corresponding attributes to ancestor nodes and descendent nodes in a unit hierarchy in the computing system, the ancestor nodes representing families of units and the descendent nodes representing particular instances of units;

detecting user configuration inputs indicative of user configuration of attributes on a corresponding property of a given unit; and

generating metadata for the corresponding property, indicative of the configuration of the attributes.

Example 17 is the computer implemented method of any or all previous examples wherein obtaining the properties comprises:

identifying a location of a node in the unit hierarchy corresponding to the selected unit;

aggregating properties and corresponding attributes from the node representing the selected unit and its ancestor nodes in the unit hierarchy.

Example 18 is the computer implemented method of any or all previous examples wherein controlling the display system comprises:

controlling the display system to display, on the user interface property display, visual category indicia indicative of which of the categories a given property belongs to.

Example 19 is a computer readable storage medium that stores computer executable instructions which, when executed by a computer, cause the computer to perform a method, comprising:

detecting a user access interaction to access properties corresponding to a selected unit represented in a computing system;

detecting one of a computing system context and an application context in which the user access interaction is detected;

obtaining a set of properties and corresponding attributes corresponding to the selected unit;

categorizing properties in the set of properties into groups, each group representing a category, based on the corresponding attributes and based on the detected context in which the user access interaction is detected;

ordering the categories into a category order; and

controlling a display system to surface the properties on a user interface property display by displaying the categories of properties in the category order by: displaying, on a user interface display device, a first category in which a property value is required for the context and no default value is provided for the property;

displaying, after the first category on the user interface display device, a second category in which a property value is required for the context and a default value is provided for the property;

displaying, after the second category on the user interface display device, a third category in which a property value is optional for the context and no default value is provided for the property; and

displaying, after the third category on the user interface display device, a fourth category in which a property value is optional for the context and a default value is provided for the property.

Example 20 is the computer readable storage medium of any or all previous examples wherein detecting one of a computing system context and an application context comprises:

detecting an application through which the user access interaction is detected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a display system that generates user interface displays;
a property identifier component that detects a user access interaction to access properties corresponding to a selected unit and that obtains the properties and corresponding attributes and categorizes the properties into a set of categories based on the corresponding attributes and based on a context in which the user access interaction is detected;
an ordering component that orders the properties in the categories in the set of categories and orders the categories into a category order; and
a display system controller that generates a user interface property display and that controls the display system to surface the properties on the user interface property display by displaying the categories of properties in the category order.

2. The computing system of claim 1 wherein the property identifier categorizes the properties into the set of categories, wherein the set of categories comprises:
a first category in which a property value is required for the context and no default value is provided for the property; and
a second category in which a property value is required for the context and a default value is provided for the property.

3. The computing system of claim 2 wherein the property identifier categorizes the properties into the set of categories, wherein the set of categories comprises:
a third category in which a property value is optional for the context and no default value is provided for the property;
a fourth category in which a property value is optional for the context and a default value is provided for the property.

4. The computing system of claim 3 wherein the ordering component orders the categories into the category order by placing the categories in order from the first category to the fourth category.

5. The computing system of claim 4 wherein the property identifier categorizes the properties into the set of categories wherein the set of categories includes a fifth category that has a read only value.

6. The computing system of claim 5 wherein the ordering component orders the properties alphabetically within each category.

7. The computing system of claim 2 and further comprising:
a visual indicia generator that generates visual category indicia on the user interface property display, the visual category indicia being indicative of which of the categories a given property belongs to.

8. The computing system of claim 7 and further comprising:
a context detector component that detects the context in response to the user access interaction.

9. The computing system of claim 8 wherein the context detector detects the context based on at least one of an application through which the user access interaction is detected and a computing system context when the user access interaction is detected.

10. The computing system of claim 8 and further comprising:
a context-based importance engine that identifies the category order based on the context detected by the context detector.

11. The computing system of claim 10 and further comprising a context-to-ordering map that maps which properties are in which categories, based on the corresponding attributes, in a given context and wherein the property identifier categorizes the properties by accessing the configurable context-to-ordering map.

12. The computing system of claim 2 wherein units are organized based on a unit hierarchy, with ancestor nodes and descendent nodes, in the computing system and further comprising:
a property configuration system detects user interactions assigning properties and corresponding attributes to the ancestor nodes and descendent nodes and wherein descendent nodes inherit properties assigned to its ancestor nodes.

13. The computing system of claim 12 wherein the property configuration system comprises:
a property configuration component that detects user configuration inputs indicative of user configuration of attributes on a corresponding property of a given unit; and
a metadata generator that generates metadata for the corresponding property, indicative of the configuration of the attributes.

14. A computer implemented method, comprising:
detecting a user access interaction to access properties corresponding to a selected unit represented in a computing system, the properties representing physical characteristics of the selected unit;
detecting a context in which the user access interaction is detected;
obtaining the properties and corresponding attributes corresponding to the selected unit;
categorizing the properties into a set of categories based on the corresponding attributes and based on the detected context in which the user access interaction is detected;
ordering the categories into a category order; and
controlling a display system to surface the properties on a user interface property display by displaying the categories of properties in the category order.

15. The computer implemented method of claim 14 wherein controlling the display system comprises:
controlling the display system to surface the properties on a user interface property display by displaying the categories of properties in the category order by: displaying a first category in which a property value is required for the context and no default value is provided for the property;
displaying, after the first category, a second category in which a property value is required for the context and a default value is provided for the property;
displaying, after the second category, a third category in which a property value is optional for the context and no default value is provided for the property; and
displaying, after the third category, a fourth category in which a property value is optional for the context and a default value is provided for the property.

16. The computer implemented method of claim 15 and further comprising:
detecting user assignment interactions assigning properties and corresponding attributes to ancestor nodes and descendent nodes in a unit hierarchy in the computing system, the ancestor nodes representing families of units and the descendent nodes representing particular instances of units;
detecting user configuration inputs indicative of user configuration of attributes on a corresponding property of a given unit; and
generating metadata for the corresponding property, indicative of the configuration of the attributes.

17. The computer implemented method of claim 16 wherein obtaining the properties comprises:
identifying a location of a node in the unit hierarchy corresponding to the selected unit;
aggregating properties and corresponding attributes from the node representing the selected unit and its ancestor nodes in the unit hierarchy.

18. The computer implemented method of claim 17 wherein controlling the display system comprises:
controlling the display system to display, on the user interface property display, visual category indicia indicative of which of the categories a given property belongs to.

19. A computer readable storage medium that stores computer executable instructions which, when executed by a computer, cause the computer to perform a method, comprising:
detecting a user access interaction to access properties corresponding to a selected unit represented in a computing system;
detecting one of a computing system context and an application context in which the user access interaction is detected;
obtaining a set of properties and corresponding attributes corresponding to the selected unit;
categorizing properties in the set of properties into groups, each group representing a category, based on the corresponding attributes and based on the detected context in which the user access interaction is detected;
ordering the categories into a category order; and
controlling a display system to surface the properties on a user interface property display by displaying the categories of properties in the category order by: displaying, on a user interface display device, a first category in which a property value is required for the context and no default value is provided for the property;
displaying, after the first category on the user interface display device, a second category in which a property value is required for the context and a default value is provided for the property;
displaying, after the second category on the user interface display device, a third category in which a property value is optional for the context and no default value is provided for the property; and
displaying, after the third category on the user interface display device, a fourth category in which a property value is optional for the context and a default value is provided for the property.

20. The computer readable storage medium of claim 19 wherein detecting one of a computing system context and an application context comprises:
detecting an application through which the user access interaction is detected.
